(19) United States
(12) Patent Application Publication
(10) Pub. No.: US 2024/0413968 A1
(43) Pub. Date: Dec. 12, 2024

(54) PROTECTION OF HOMOMORPHIC ENCRYPTION COMPUTATIONS BY MASKING WITHOUT UNMASKING

(71) Applicant: Cryptography Research, Inc., San Jose, CA (US)

(72) Inventors: Mark Evan Marson, Carlsbad, CA (US); Michael Alexander Hamburg, ‘s-Hertogenbosch (NL); Helena Handschuh, Miami, FL (US)

(21) Appl. No.: 18/732,270

(22) Filed: Jun. 3, 2024

Related U.S. Application Data
(60) Provisional application No. 63/471,314, filed on Jun. 6, 2023.

(51) Int. Cl. H04L 9/00; H04L 9/06

(52) U.S. Cl. CPC H04L 9/008; H04L 9/0618

(57) ABSTRACT

Aspects and implementations are directed to systems and techniques for protecting cryptographic operations against side-channel attacks by masking a ciphertext data using one or more masks randomly sampled from a null space associated with a tensor representation of a secret data and generating a plaintext data using the masked ciphertext data.

### RELATED APPLICATIONS

This application claims the benefit of U.S. Provisional Application No. 63/471,314, filed Jun. 6, 2023, the entire contents of which is being incorporated herein by reference.

### TECHNICAL FIELD

Aspects of the present disclosure are directed to cryptographic computing applications, more specifically to protection of homomorphic cryptographic computations from side-channel attacks.

### BRIEF DESCRIPTION OF THE DRAWINGS

The present disclosure will be understood more fully from the detailed description given below and from the accompanying drawings of various implementations of the disclosure.

FIG. 1 illustrates an example computing architecture in which various implementations of the present disclosure may operate.

FIG. 2 is a block diagram illustrating an example computing system capable of protecting secret data against side-channel attacks using masking without additional unmasking calculations, in accordance with one or more aspects of the present disclosure.

FIG. 3 is an example data flow of a decryption process that uses masking without additional unmasking calculations for efficient protection against side-channel attacks, in accordance with one or more aspects of the present disclosure.

FIG. 4 depicts a flow diagram of an example method of masking without additional unmasking calculations for efficient protection of cryptographic applications against side-channel attacks, in accordance with one or more aspects of the present disclosure.

FIG. 5 depicts a block diagram of an example computer system 500 operating in accordance with one or more aspects of the present disclosure.

### DETAILED DESCRIPTION

Typical cryptographic systems and applications allow operations with encrypted data after the encrypted data has been decrypted. More specifically, a secret plaintext message P may be encrypted into a ciphertext C and communicated to a recipient (e.g., over a public channel). The recipient may perform a decryption operation to restore the plaintext, P=Dec(C). After decryption, various arithmetic operations may be performed on decrypted plaintexts, e.g., P₁+P₂, P₁·P₂, etc. Homomorphic encryption techniques enable operating directly on ciphertexts. For example, partially homomorphic encryption (PHE) techniques may allow performing multiplications of ciphertexts with the resulting product representing a correct ciphertext of the corresponding product of plaintexts, P₁·P₂=Dec(C₁·C₂)=Dec(C₁)·Dec(C₂). In particular, Rivest-Shamir-Adleman (RSA) ciphers possess this property. Fully homomorphic encryption (FHE) techniques enable performing any computations directly on ciphertexts, P₁⋄P₂=Dec(C₁⋄C₂)=Dec(C₁)⋄Dec(C₂), where ⋄ stands for addition/subtraction, multiplication, modular multiplication, division, exponentiation, and/or the like.

FHE systems allow large-scale processing of confidential data without revealing the data to the processing party. For example, an untrusted server (e.g., a cloud-based server) may be provided a set of encrypted (e.g., with a public key) ciphertexts {Cᵢ} (for example, encrypted confidential patient data). The server may perform any applicable processing, including artificial intelligence (AI) processing, of ciphertexts {Cᵢ} (such as medical diagnostics processing), generate ciphertext outputs, and provide the outputs to a recipient of the data. The recipient may then apply a private key to decrypt the outputs (e.g., to access medical diagnostics results). Such processing allows one to take full advantage of powerful processing facilities provided by untrusted parties.

Although the encrypted confidential data may be protected from unauthorized accesses while in the ciphertext form, a weak security link may occur on the recipient's side. In particular, decryption of FHE ciphertexts typically includes computing products (e.g., vector or matrix products) of ciphertexts C₁, C₂, C₃ . . . and some secret data S (e.g., a private key or data derived from the private key). As the same secret data is multiplied over and over by varying and known (to the attacker) ciphertexts, the secret data may become vulnerable to side-channel attacks. During a side-channel attack, an attacker observes a large number of multiplications S·C₁, S·C₂, S·C₃ . . . and monitors signals produced by electronic circuits of a targeted computer. Monitored signals may be acoustic, electrical, magnetic, optical, thermal, and so on. By recording such signals, a hardware trojan and/or a malicious software may correlate specific processor (and/or memory) activity with operations carried out by the targeted computer. A simple power analysis (SPA) side-channel attack may involve examination of the electric power used by the device as a function of time. As presence of noise hides the signal of the processor/memory, a more sophisticated differential power analysis (DPA) attack may involve undertaking statistical analysis of power measurements performed over multiple cryptographic operations (or multiple iterations of a single cryptographic operation). An attacker employing DPA may filter out the noise component of the power signal (using the fact that the noise components may be uncorrelated between different operations or iterations) to extract the component of the signal that is representative of the actual processor activity, and to infer the value of the secret data S from this signal, gaining access to the private key.

Protection against side-channel attacks includes various masking techniques. Masking involves generating a random (or pseudorandom) masking data M and combining (e.g., adding, multiplying, etc.) the masking data with secret data S to reduce correlations of side-channel measurements with the secret data. Masking, however, comes at the cost of additional computations, since it is typically necessary to perform computations on both the masked data (e.g., S+M) and the masking data M separately before using the results of these two (or more) computations to unmask a final output. This increases latency, reduces computational throughput, and consumes valuable processing and memory resources.

Aspects and implementations of the present disclosure address these and other challenges of the existing technology by enabling FHE systems and techniques to implement masking that does not require separate computations on the masked data and the masking data and does not require additional unmasking operations. Masks M are generated in such a way as to mask a ciphertext C→C_{M} without changing the result of an application of the secret data to the ciphertext, S·C_{M}=S·C, causing the masks to be nullified during decryption without additional unmasking. More specifically, a null space of secret data S may be evaluated and a set of basis vectors {bₖ} for the null space may be determined (e.g., precomputed and stored in memory, in some implementations). A mask M may be sampled from the null space, e.g., as a random or pseudorandom combination of the basis vectors, and used to modify the ciphertext, C→C_{M}. By virtue of sampling the mask M from the null space, the ciphertext C_{M} does not require any additional unmasking beyond operations of a decryption protocol. Other masking techniques that zero out at the end of computations and that do not rely on the use of the null space are also disclosed herein. For example, in some encryption-decryption schemes, computations are performed modulo some (large) number q or modulo some polynomial q(x). A mask that includes a random or pseudorandom multiple of such moduli may be added to a ciphertext with the result that the mask does not affect the final output of the modular computation. This and various other disclosed techniques are not limited to FHE and may be used in a variety of cryptographic systems and applications.

Numerous additional implementations are disclosed herein. The advantages of the disclosed implementations include, but are not limited to, secure execution of cryptographic applications using masking techniques that do not require separate unmasking operations. The disclosed implementations may be used in public key cryptography, symmetric key cryptography, digital signature algorithms, fully homomorphic encryption, partially homomorphic encryption, and/or various other cryptographic applications.

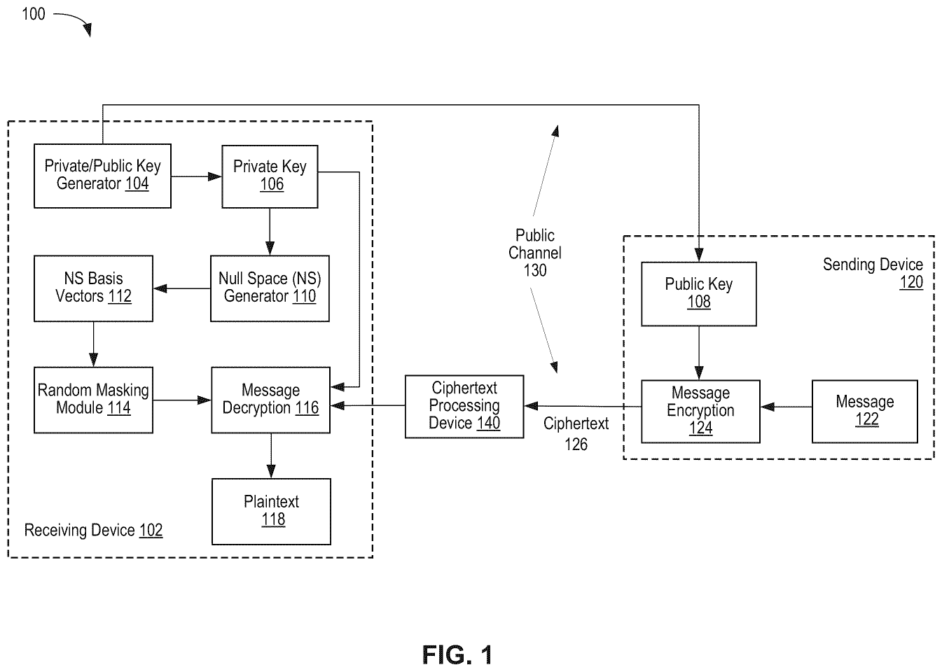

FIG. 1 illustrates an example computing architecture 100 in which various implementations of the present disclosure may operate. For illustration, computing architecture 100 implements public/private key cryptography, but a similar architecture may be used in symmetric key cryptographic applications. Computing architecture 100 may include various components/modules/applications that are not explicitly depicted in FIG. 1, including but not limited to various domain-specific applications that perform operations on output or input messages. Computing architecture 100 may include a receiving device 102 deploying a cryptographic application-specific private/public key generator 104 that may generate a private key 106 and a public key 108. Receiving device 102 may provide public key 108 to a sending device 120, which uses public key 108 to encrypt a message 122 before sending ciphertext (encrypted message) 126 over a public communication channel 130, which may include any network, e.g., Internet, local area network, wide area network, and/or the like. Message 122 may be encrypted by a message encryption module 124 implementing any suitable encryption scheme. In some implementations, the encryption scheme may be one of the FHE schemes, including but not limited to the Gentry-Sahai-Waters (GSW) scheme, the Brakerski-Gentry-Vaikuntanathan (BGV) scheme, the Brakerski-Fan-Vercauteren (BFV) scheme, FHEW/TFHE schemes, the Cheon-Kim-Kim-Song (CKKS) scheme, and/or the like. Ciphertext(s) 126 may be processed by any suitable ciphertext processing device 140 (e.g., a cloud-based processing server), which may implement AI processing or some other type of processing directly on ciphertexts 126 without decrypting ciphertext(s). Ciphertext(s) 126 (or processed and modified ciphertext(s) 126) may then be provided to receiving device 102.

Receiving device 102 may deploy a null space generator 110 that determines the null space, e.g., basis vectors of the null space, associated with private key 106. In some implementations, the null space vectors 112 may be computed at a time prior to receiving the ciphertexts from sending device 120 and/or ciphertext processing device 140. For example, the null space vectors 112 may be generated at a time of the private key 106 generation. The null space vectors 112 may be used by a random masking module 114 that samples masks from the null space and provides the masks to a message decryption module 116. Message decryption module 116 may implement the same cryptographic protocol as the message encryption module 124 does and may decrypt the received ciphertext(s) to obtain corresponding plaintext(s) 118. As disclosed herein, message decryption module 116 may receive the ciphertexts and the masks and may implement masked decryption without exposing the private key 106 (or any other secret data derived from private key 106) to a side-channel attacker during operations with the received ciphertexts. Although, for illustration, ciphertext(s) and plaintext(s) are generated/processed by different devices in the illustration of FIG. 1, in some instances ciphertext(s) and plaintext(s) may be generated/processed by the same device. For example, sending device 120 may be the same device as receiving device 102.

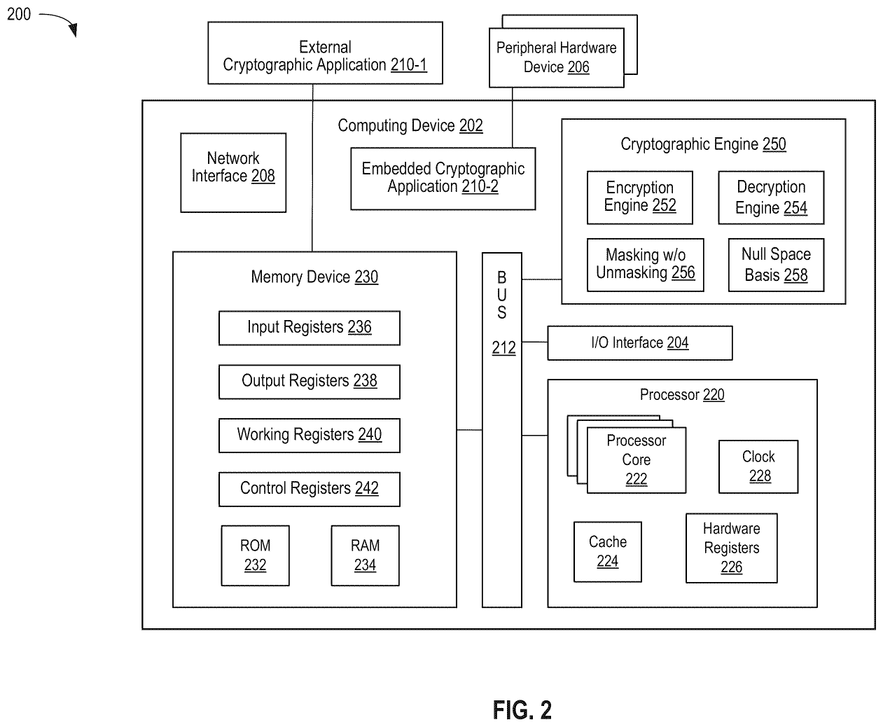

FIG. 2 is a block diagram illustrating an example computing system 200 capable of protecting secret data against side-channel attacks using masking without additional unmasking calculations, in accordance with one or more aspects of the present disclosure. Example computing system 200 may be a desktop computer, a tablet, a smartphone, a server (local or remote), a thin/lean client, and the like. Example computing system 200 may be a smart card reader, a wireless sensor node, an embedded system dedicated to one or more specific applications (e.g., cryptographic applications 210-n), and so on. Example computing system 200 may include (but need not be limited to) a computing device 202 having one or more processors 220 (e.g., central processing units (CPUs)) capable of executing binary instructions, and one or more memory devices 230. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Example computing system 200 may include an input/output (I/O) interface 204 to facilitate connection of computing device 202 with peripheral hardware devices 206 such as card readers, terminals, printers, scanners, internet-of-things devices, and the like. Example computing system 200 may further include a network interface 208 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 202. For example, network interface 208 may be used to support a connection to sending device 120 and/or ciphertext processing device 140 of FIG. 1. Various hardware components of computing device 202 may be connected via a bus 212, which may have its own logic circuits.

Example computing system 200 may support one or more cryptographic applications 210-n, such as an external cryptographic application 210-1 and/or embedded cryptographic application 210-2. Cryptographic applications 210-n may be secure authentication applications, public key signature applications, key encapsulation applications, key decapsulation applications, encryption applications, decryption applications, fully homomorphic encryption/decryption applications, secure storage applications, and so on. External cryptographic application 210-1 may be instantiated on the same computing device 202, e.g., by an operating system executed by the processor 220 and residing in a memory device 230. Alternatively, external cryptographic application 210-1 may be instantiated by a guest operating system supported by a virtual machine monitor (hypervisor) executed by the processor 220. In some implementations, external cryptographic application 210-1 may reside on a remote access client device or a remote server (not shown), with the computer device 202 providing cryptographic support for the client device and/or the remote server.

Processor 220 may include one or more processor cores 222 having access to cache 224 (e.g., a single-level or multi-level cache) and one or more hardware registers 226. In some implementations, each processor core 222 may execute instructions to run a number of hardware threads, also known as logical processors. Various logical processors (or processor cores) may be assigned to one or more cryptographic applications 210-n, although more than one processor may be assigned to a single cryptographic application for parallel processing. Memory device 230 may refer to a volatile or non-volatile memory and may include a read-only memory (ROM) 232, a random-access memory (RAM) 234, as well as (not shown) electrically erasable programmable read-only memory (EEPROM), flash memory, flip-flop memory, or any other device capable of storing data. RAM 234 may be a dynamic random access memory (DRAM), synchronous DRAM (SDRAM), a static memory, such as static random access memory (SRAM), and the like.

Memory device 230 may include one or more registers, such as one or more input registers 236 to store cryptographic keys, input polynomials, and other data for cryptographic applications 210-n. Memory device 230 may further include one or more output registers 238 to store outputs of cryptographic application, and one or more working registers 240 to store various intermediate values generated in the course of performing cryptographic computations, including masking operations. Memory device 230 may also include one or more control registers 242 for storing information about modes of operation, selecting a cryptographic algorithm, initializing cryptographic computations, selecting a masking mode, sampling from a null space of secret data, modifying ciphertexts with sampled masks, and/or the like. Control registers 242 may communicate with one or more processor cores 222 and a clock 228, which may keep track of an iteration being performed. In some implementations, registers 236-142 may be implemented as part of RAM 234. In some implementations, some or all of the registers 236-242 may be implemented separately from RAM 234. Some of or all registers 236-242 may be implemented as part of processor 220 (e.g., as part of the hardware registers 226). In some implementations, processor 220 and memory device 230 may be implemented as a single field-programmable gate array (FPGA).

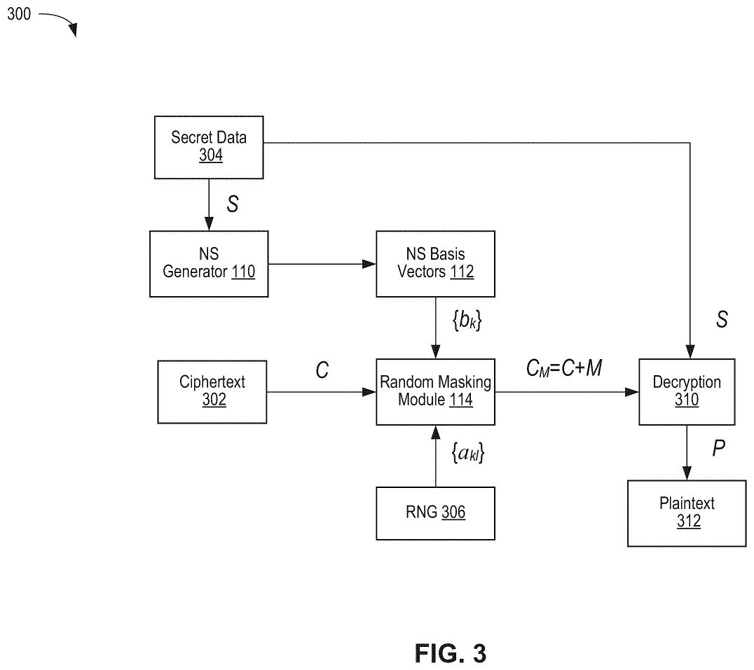

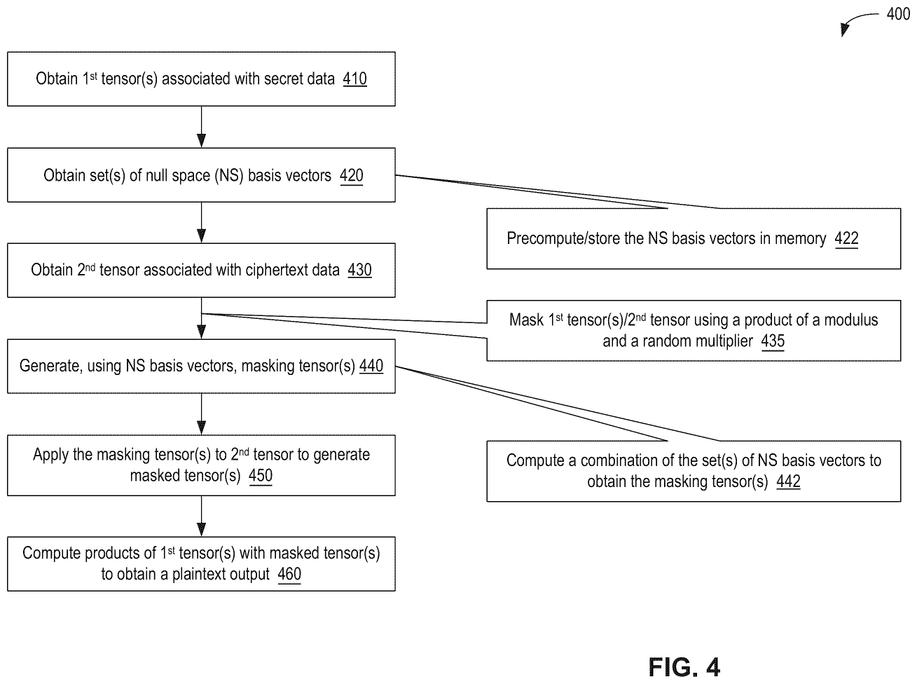

Computing device 202 may include a cryptographic engine 250 to support cryptographic operations of processor 220. Cryptographic engine 250 may be configured to perform side-channel attack-resistant cryptographic operations, in accordance with implementations of the present disclosure. As depicted in FIG. 2, cryptographic engine 250 may be a separate hardware component, e.g., an accelerator. In some implementations, cryptographic engine 250 may be implemented as a software (or firmware) module instantiated in memory device 230. In some implementations, cryptographic engine 250 may be partially implemented as a hardware component and partially as a software (or firmware) module. Cryptographic engine 250 may include an encryption engine 252 to encrypt plaintext messages and generate ciphertexts. Cryptographic engine 250 may also include a decryption engine 254 to decrypt ciphertexts and recover plaintext messages. Decryption engine 254 (and, in some implementations, encryption engine 252) may deploy a masking without unmasking module 256 to implement one or more techniques of the present disclosure, e.g., as described in more detail in conjunction with FIG. 3 and FIG. 4 below. In some implementations, masking without unmasking may use a null space basis 258 of secret data used by decryption engine 254.

FIG. 3 is an example data flow of a decryption process 300 that uses masking without additional unmasking calculations for efficient protection against side-channel attacks, in accordance with one or more aspects of the present disclosure. In some implementations, decryption process 300 may be performed by various components and/or modules of receiving device 102 of FIG. 1, e.g., cryptographic engine 250 of FIG. 2. In some implementations, decryption process 300 may be performed in the course of decryption of a ciphertext 302, which may be any message encrypted using a suitable cryptosystem, e.g., an FHE system, a PHE system, or some other cryptosystem. Decryption of ciphertext 302 may involve using a secret data 304, which may be any cryptographic key permanently stored on receiving device 102, ephemeral key or session key generated for a particular cryptographic episode, key generated to decrypt a particular message or a portion of a message, and the like. In some implementations, ciphertext 302 may have been obtained from a plaintext message by computing a multiplication product of a numerical representation (e.g., vector, matrix, etc.) of the plaintext message and a publicly available generating matrix, corrupting the computed product by adding (a vector or matrix of) randomly generated errors, and/or performing any other operations according to a particular encryption protocol being deployed.

Operations of decryption process 300 will now be disclosed using an illustrative non-limiting example of the GSW FHE scheme. In the GSW FHE scheme, a ciphertext 302 may be represented via an n×m matrix C. (Typically, the horizontal dimension m of ciphertext matrix C is substantially larger than its vertical dimension n.) Secret data 304 may be represented via an n×1 vector s. Throughout the present disclosure, lowercase letters (e.g., s) indicate vectors and uppercase letters (e.g., C) indicate matrices. Vectors and matrices are jointly referred to as tensors herein (e.g., with vectors being tensors of order one and matrices being tensors of order two). A decryption stage 310 may include computing a product (an 1×m vector),

$$p = {s}^{T} \cdot C ,$$

which may represent plaintext 312 or may be used to obtain plaintext 312. To protect product p against side-channel attacks, decryption process 300 may deploy null space generator 110 to obtain a set of null space basis vectors 112, {bₖ}=b₁, b₂ . . . bₙ₋₁, that are orthogonal to secret data 304: s^{T}·bₖ=0. In some implementations, null space basis vectors 112 may be computed (e.g., at the time of generation of secret data 304) and stored in a memory of a computing device implementing decryption process 300. The null space basis vectors 112 may be found using the echelon technique by any other known linear algebra methods.

To generate a mask, random masking module 114 may receive a set of random coefficients {aₖₗ}, which may be an (n−1)×m matrix. Matrix aₖₗ may be generated by any suitable random (or pseudorandom) number generator 306. Matrix aₖₗ may be used to construct m vectors (of dimension n×1) mₗ, where l=1 . . . m, e.g.,

$${m}_{l} = {\sum }_{k = 1}^{n - 1} {b}_{k} {a}_{k l} .$$

The set of constructed vectors {mⱼ} may then be combined into an n×m masking matrix M=[m₁, m₂, . . . mₘ]. The masking matrix M may be used by random masking module 114 to compute a masked ciphertext C_{M}:

$${C}_{M} = C + M .$$

The masked ciphertext C_{M} may be provided to decryption module 310, which may compute the product (e.g., plaintext 312) p=s^{T}·C_{M}, which is equal to the same product for the unmasked ciphertext p=s^{T}·C. This is ensured by the fact that the product of the secret data and the masking matrix is zero s^{T}·M=0, since each column of the masking matrix is a linear combination of null space basis vectors. As a result, during decryption, decryption module 310 obtains plaintext 312 without performing any additional unmasking operations and/or separate operations on the mask M.

In some implementations, various addition and multiplication operations referenced above may be modular operations (mod q) performed on a ring Z_{q}, with any suitable modulus q.

Operations of decryption process 300 may also be illustrated using a second non-limiting example of the BVF FHE scheme. In the BVF FHE scheme, ciphertext 302 and secret data 304 may be elements that are polynomials on the ring R_{q}=Z_{q}[x]/(xⁿ+1), namely polynomials of degree n−1 whose multiplications are defined modulo the irreducible polynomial xⁿ+1 or some other irreducible polynomial of degree n. Secret data 304 may be transformed from an n×1 vector of coefficients to an n×n matrix S, each element of the matrix being an element of Z_{q}. Matrix S may have the same number of different elements as the underlying vector, e.g., may be a circulant matrix in which various rows or columns are obtained by rearranging a single row or column that is derived from the underlying vector.

Decryption stage 310 may include computing a product (an n×1 vector),

$$p = S \cdot c ,$$

which may be plaintext 312 or may be used to obtain plaintext 312. To protect product p against side-channel attacks, decryption process 300 may deploy null space generator 110 to obtain a set of null space basis vectors 112 for two (or more) matrices S₁, S₂ . . . that add up to the secret data matrix, S=S₁+S₂+ . . . , and are referred to as shares of the secret data herein. Null space basis vectors 112 may be found for each of the shares separately, {bₖ⁽¹⁾}, {bₖ⁽²⁾} . . . , each set potentially having the same or a different number of basis vectors determined by a rank of the respective share Sᵢ. In the BVF FHE scheme, the secret data matrix S is typically invertible and thus has the maximum possible rank n (meaning that S has no null space). Splitting the matrix S into multiple shares opens up the possibility for each of the shares S₁, S₂ . . . to have a null space. The choice of ranks r₁, r₂ . . . of the respective shares allows some flexibility. The ranks sum up to at least the rank of the secret data matrix S: r₁+r₂+ . . . ≥n. For example, if the secret data matrix is split into two shares, the shares may have the ranks that are at least n/2, e.g., 2n/3 (in which case the dimension of the null space of the shares is n/3), 3n/4, and/or the like. If the secret data matrix is split into three shares, the shares may have the ranks that are at least n/3, e.g., n/2 (in which case the dimension of the null space of the shares is n/2), 2n/3, and so on. Larger null spaces ensure higher entropy of the masking.

The sets of vectors {bₖ⁽ⁱ⁾} being basis vectors of the null space of the respective share Sᵢ means that

$${S}_{i} \cdot {b}_{k}^{( i )} = 0 , k = 1 , 2 … n - {r}_{i} .$$

To generate a mask, random masking module 114 may receive a set of random coefficients {aₖₗ} generated by random number generator 306 and construct a masking vector m^{(l)} for each of the shares i, e.g.,

$${m}^{( l )} = {\sum }_{k = 1}^{n - {r}_{l}} {a}_{k l} {b}_{k}^{( l )} .$$

The set of constructed vectors m^{(l)} may then be used by random masking module 114 to compute a set of masked ciphertext vectors c_{M}^{(l)}:

$${c}_{M}^{( l )} = c + {m}^{( l )} .$$

The masked vectors c_{M}^{(l)} may be provided to decryption module 310, which may compute products of the masked vectors with the respective shares of the secret data, yielding the product (e.g., plaintext 312),

$$p = {S}_{1} \cdot {c}_{M}^{( 1 )} + {S}_{2} \cdot {c}_{M}^{( 2 )} + … = {S}_{1} \cdot ( c + {m}^{( 1 )} ) + {S}_{2} \cdot ( c + {m}^{( 2 )} ) + … = {S}_{1} \cdot c + {S}_{2} \cdot c + … = ( {S}_{1} + {S}_{2} + … ) \cdot c = S \cdot c , \qquad ( 1 )$$

that is equal to the same product for the unmasked ciphertext p=S·c. This is ensured by the fact that the product of each share of the secret data and the respective masking vector is zero, Sₗ·m^{(l)}=0, since the masking vector is a linear combination of null space basis vectors for the share. As a result, during decryption, decryption module 310 obtains plaintext 312 without performing any additional unmasking operations and/or separate operations on the masks m^{(l)}. Various addition and multiplication operations referenced above may be modular operations (mod q) performed on the polynomial ring R_{q}.

FIG. 4 depicts a flow diagram of an example method 400 of masking without additional unmasking calculations for efficient protection of cryptographic applications against side-channel attacks, in accordance with one or more aspects of the present disclosure. Method 400 disclosed below, and/or each of its individual functions, routines, subroutines, or operations may be performed by one or more processing units of any suitable computing system, e.g., by processor 220 and/or cryptographic engine 250 of computing device 202. In some implementations, method 400 may be performed by an arithmetic logic unit, an FPGA, an ASIC, a cryptographic accelerator, a dedicated hardware circuit, and the like, or any suitable processing logic, hardware or software or a combination thereof. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Various operations of method 400 may be performed in a different order compared with the order shown in FIG. 4. Some blocks of method 400 may be performed concurrently with other blocks. Some blocks of method 400 may be optional.

In some implementations, a cryptographic operation protected by method 400 may include a fully homomorphic cryptographic operation. For example, the fully homomorphic cryptographic operation may include a GSW cryptographic operation, a BFV cryptographic operation, or the like. Method 400 may include, at block 410, obtaining one or more first tensors associated with a secret data. “Tensor,” as used herein, should be understood as any ordered set of elements (e.g., numbers or polynomials) having one dimension (vector), two dimensions (matrix), or more dimensions. For example, in GSW implementations, the one or more first tensors may include a vector associated with the secret data (e.g., vector s or the transposed vector s^{T}). As another example, in BVF implementations, the one or more first tensors may include a plurality of shares of a matrix associated with the secret data (e.g., shares Sⱼ of matrix S=S₁+S₂+ . . . ). In some implementations, a number of the plurality of shares S of the matrix (S=S₁+S₂+ . . . ) is N and a rank of the matrix is n, and each share of the plurality of shares of the matrix has a rank that is at or below n(N+1)/2N. For example, if the number of shares is N=2, 3, etc., the rank of each share may be at or below 3n/4, 2n/3, etc. In some implementations, any or some of the shares of the matrix may have a rank that is above n(N+1)/2N.

At block 420, the processing device performing method 400 may continue with identifying one or more sets of null space (NS) basis vectors for the one or more first tensors. In some implementations (e.g., GSW implementations), one set of NS basis vectors {bₖ} may be identified for a single vector of secret data (e.g., vector s or s^{T}). In some implementations (e.g., BVF implementations) multiple sets of basis vectors, {bₖ^{(l)}}, {bₖ⁽²⁾} . . . , may be identified, one for each share of the plurality of shares of the matrix associated with the secret data (e.g., one set of basis vectors for each of the shares S₁, S₂, . . . ).

In some implementations, as illustrated with callout block 422, the one or more sets of NS basis vectors may be precomputed and stored in a memory communicatively coupled to the processing device (e.g., one or more registers, cache, RAM, and/or the like). In such implementations, obtaining the one or more sets of NS basis vectors may include retrieving the precomputed set(s) of NS basis vectors from the memory.

At block 430, method 400 may include obtaining a second tensor associated with a ciphertext data. In some implementations (e.g., GSW implementations), the second tensor may include a matrix associated with the ciphertext data (e.g., matrix C). The elements of the matrix C and the vector s may include numbers defined on a finite field. In some implementations (e.g., BVF implementations) the second tensor may include a vector associated with the ciphertext data (e.g., vector c). The elements of the matrix S and the vector c may include polynomials defined on a finite field.

At block 440, the processing device performing method 400 may generate, using the one or more sets of NS basis vectors, one or more masking tensors. In some implementations (e.g., GSW implementations), one masking matrix M may be generated. In some implementations (e.g., BVF implementations) multiple masking vectors m^{(l)} may be generated. In some implementations, as illustrated with callout block 442, generating the one or more masking tensors may include (e.g., as disclosed in conjunction with FIG. 3) computing, using a plurality of random or pseudorandom numbers, a combination of the one or more sets of the NS basis vectors.

At block 450, method 400 may continue with the processing device applying the one or more masking tensors to the second tensor to generate one or more masked tensors (e.g., masked matrix C+M or masked vectors c+m^{(l)}). At block 460, method 400 may include obtaining a plaintext output of the cryptographic operation. The plaintext output may include computing one or more multiplication products of the one or more first tensors with the one or more masked tensors (e.g., computing a product s^{T}·C_{M} or multiple products Sⱼ·(c+m^{(j)})). In some implementations, the one or more multiplication products may be computed modulo a certain modulus, which may include a number (e.g., q) and/or an irreducible polynomial (e.g., x^{p}+1).

In some implementations, as illustrated with callout block 435, additional masking of the one or more first tensors or the second tensor (or both) may include computing an additional masking product of the modulus and a random multiplier and adding or subtracting the masking product to each element of the one or more first tensors or each element of the second tensor (or both).

The obtained plaintext output(s) of the cryptographic operation may be used in any suitable way as directed by an application that is the intended recipient of the plaintext data. The application may include a medical application, a robotic application, an AI application (e.g., a deep learning application, a generative model, and/or the like), an automotive application, a security application, a surveillance application, a cloud-based application, a virtual/mixed reality application, a data center application, and/or other types of application.

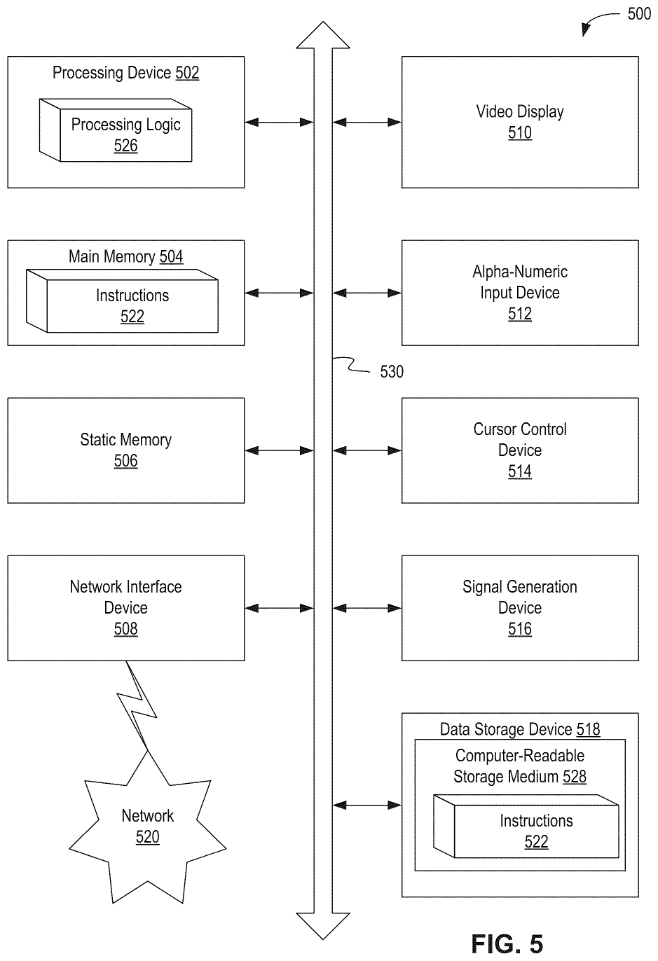

FIG. 5 depicts a block diagram of an example computer system 500 operating in accordance with one or more aspects of the present disclosure. In various illustrative examples, computer system 500 may represent computing device 202, illustrated in FIG. 2. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 526, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing example method 400 of masking without additional unmasking calculations for efficient protection of cryptographic applications against side-channel attacks.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing example method 400 of masking without additional unmasking calculations for efficient protection of cryptographic applications against side-channel attacks.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
obtaining one or more first tensors associated with a secret data;
obtaining, by a processing device, one or more sets of null space (NS) basis vectors for the one or more first tensors;
obtaining a second tensor associated with a ciphertext data;
generating, using the one or more sets of NS basis vectors, one or more masking tensors;
applying, by the processing device, the one or more masking tensors to the second tensor to generate one or more masked tensors; and
obtaining, by the processing device, a plaintext output of the cryptographic operation, wherein obtaining the plaintext output comprises computing one or more multiplication products of the one or more first tensors with the one or more masked tensors.

2. The method of claim 1, wherein the cryptographic operation comprises a fully homomorphic cryptographic operation.

3. The method of claim 2, wherein the fully homomorphic cryptographic operation comprises one of:
a Gentry-Sahai-Waters (GSW) cryptographic operation, or
a Brakerski-Fan-Vercauteren (BFV) cryptographic operation.

4. The method of claim 1, wherein the one or more first tensors comprise a vector associated with the secret data, and wherein the second tensor comprises a matrix associated with the ciphertext data.

5. The method of claim 1, wherein the one or more first tensors comprise a plurality of shares of a matrix associated with the secret data, and wherein the second tensor comprises a vector associated with the ciphertext data.

6. The method of claim 5, wherein a number of the plurality of shares of the matrix is N and a rank of the matrix is n, and wherein each share of the plurality of shares of the matrix has a rank that is at or below n(N+1)/2N.

7. The method of claim 5, wherein elements of the matrix and the vector comprise polynomials defined on a finite field.

8. The method of claim 1, wherein generating the one or more masking tensors comprises:
computing, using a plurality of random or pseudorandom numbers, a combination of the one or more sets of the NS basis vectors.

9. The method of claim 1, wherein the one or more sets of NS basis vectors are precomputed, and wherein obtaining the one or more sets of NS basis vectors comprises retrieving the precomputed one or more sets of NS basis vectors from a memory communicatively coupled to the processing device.

10. The method of claim 1, wherein the one or more multiplication products are computed modulo a modulus, wherein the modulus comprises at least one of:
a number, or
an irreducible polynomial.

11. The method of claim 10, further comprising:
masking at least one of the one or more first tensors or the second tensor using a masking product of the modulus and a random multiplier.

12. The method of claim 11, further comprising:
adding or subtracting the masking product to:
each element of the one or more first tensors, or
each element of the second tensor.

13. A system comprising:
a memory device; and
a processing device communicatively coupled to the memory device, the processing device to:
obtain one or more first tensors associated with a secret data;
obtain one or more sets of null space (NS) basis vectors for the one or more first tensors;
obtain a second tensor associated with a ciphertext data;
generate, using the one or more sets of NS basis vectors, one or more masking tensors;
apply the one or more masking tensors to the second tensor to generate one or more masked tensors; and
obtain a plaintext output of a cryptographic operation, wherein obtaining the plaintext output comprises computing one or more multiplication products of the one or more first tensors with the one or more masked tensors.

14. The system of claim 13, wherein the cryptographic operation comprises a fully homomorphic cryptographic operation.

15. The system of claim 13, wherein the one or more first tensors comprise at least one of:
a vector associated with the secret data, wherein the second tensor comprises a matrix associated with the ciphertext data; or
a plurality of shares of a matrix associated with the secret data, wherein the second tensor comprises a vector associated with the ciphertext data.

16. The system of claim 13, wherein elements of the one or more first tensors comprise at least one of:
numbers defined on a first finite field, or
polynomials defined on a second finite field.

17. The system of claim 13, wherein to generate the one or more masking tensors, the processing device is to:
compute, using a plurality of random or pseudorandom numbers, a combination of the one or more sets of the NS basis vectors.

18. The system of claim 13, wherein the one or more sets of NS basis vectors are precomputed, and wherein to obtain the one or more sets of NS basis vectors, the processing device is to retrieve the precomputed one or more sets of NS basis vectors from the memory.

19. The system of claim 13, wherein the one or more multiplication products are computed modulo a modulus comprising at least one of a number or an irreducible polynomial, and wherein the processing device is further to:
mask at least one of the one or more first tensors or the second tensor, by adding to or subtracting from each element of the tensors being masked, a masking product of the modulus and a random multiplier.

20. A system comprising:
a memory device; and
a processing device communicatively coupled to the memory device, the processing device to:
mask a ciphertext data using one or more masks randomly sampled from a null space associated with a tensor representation of a secret data; and
generate a plaintext data using the masked ciphertext data.
